(19) United States
(12) Patent Application Publication
(10) Pub. No.: US 2022/0132923 A1
(43) Pub. Date: May 5, 2022

(54) Electronic Cigarette With Audible Connection

(71) Applicant: JT International S.A., Geneva (CH)

(72) Inventors: Kyle ADAIR, Lisburn (GB); Andrew Robert John ROGAN, Forres (GB)

(73) Assignee: JT International S.A., Geneva (CH)

(21) Appl. No.: 17/430,787

(22) PCT Filed: Mar. 6, 2020
(86) PCT No.: PCT/EP2020/056115

§ 371 Date: Aug. 13, 2021

(30) Foreign Application Priority Data
Mar. 8, 2019 (EP) 19161641.6

(51) Int. Cl. A24F 40/42; A24F 40/60

(52) U.S. Cl. CPC A24F 40/42; A24F 40/60

(57) ABSTRACT

An electronic cigarette includes an inhaler body and a removable cartridge, the inhaler body including: a power unit and a cartridge seating including a cavity arranged to receive the cartridge in a retained position within the cavity, wherein, in the retained position, opposing surfaces of the cartridge and cartridge seating are in contact and the cartridge is electrically connected to the power unit; the electronic cigarette further including: a magnet arranged to provide a magnetic force to draw the removable cartridge into the retained position; wherein the cartridge, the cartridge seating and the magnetic force are configured such that when the cartridge is released within the cavity, the cartridge is accelerated under the force of the magnet such that an audible signal is generated upon contact between the opposing surfaces when as the cartridge is received in the retained position to provide a reliable audible indication to a user.

The present invention relates to an electronic cigarette, in particular an electronic cigarette able to receive a replaceable cartridge.

### BACKGROUND

Electronic cigarettes are an alternative to conventional cigarettes. Instead of generating a combustion smoke, they vaporize a liquid, which can be inhaled by a user. The liquid typically comprises an aerosol-forming substance, such as glycerin or propylene glycol that creates the vapor. Other common substances in the liquid are nicotine and various flavorings.

The electronic cigarette is a hand-held inhaler system, comprising a mouthpiece section, a liquid store and a power supply unit. Vaporization is achieved by a vaporizer or heater unit which typically comprises a heating element in the form of a heating coil and a fluid transfer element, such as a wick, arranged to transfer fluid from the liquid store to the heating element. Vaporisation occurs when the heater heats up the liquid in the fluid transfer element until the liquid is transformed into vapor. The vapor can then be inhaled via an air outlet in the mouthpiece.

The electronic cigarette may comprise a cartridge seating in the power supply section of the device, which is configured to receive disposable consumables in the form of cartridges. Cartridges comprising the liquid store and the vaporizer are often referred to as “cartomizers”. In this case, the vaporizer of the cartomizer is connected to the power supply unit when received in the cartridge seating such that electricity can be supplied to the heater of the cartomizer to heat the liquid to generate the vapor. Often some form of mechanical mechanism is used to retain the cartridge in the cartridge seating such that it does not fall out and separate from the device.

There exists a problem in such prior art devices in that it is not always clear to a user when the required mechanical and electrical connection has been made such that the device is ready to use. Furthermore, even if one of the mechanical and electrical connection have been made, it is not clear that the other has been established. This can result in the cartridge falling out of the device during use or encouraging the user to exert excessive pressure on the cartridge in an effort to make the connection, causing damage to the components of the device.

### SUMMARY

It is an object of the present invention to provide an electronic cigarette which makes progress in solving some of the problems of prior art devices identified above.

In a first aspect of the invention there is provided an electronic cigarette comprising an inhaler body and a removable cartridge, the inhaler body comprising: a power unit and a cartridge seating, the cartridge seating comprising a cavity arranged to receive the cartridge in a retained position within the cavity, wherein, in the retained position, opposing surfaces of the cartridge and cartridge seating are in contact and the cartridge is electrically connected to the power unit; the electronic cigarette further comprising: a magnet arranged to provide a magnetic force to draw the removable cartridge into the retained position; wherein the cartridge, the cartridge seating and the magnetic force are configured such that when the cartridge is released within the cavity, the cartridge is accelerated under the force of the magnet such that an audible signal is generated upon contact between the opposing surfaces as the cartridge is received in the retained position.

In this way, the audible signal provides feedback to the user that the cartridge is mechanically and electrically connected to the inhaler body such that the device is ready for use. Because in the received position the opposing surfaces (which generate the audible signal) are in contact and the cartridge is connected to the power unit, the audible signal can be associated with the electrical connection of the cartridge such that it can provide a reliable indicator that the device is ready for use.

The term “an audible signal” is used to refer to a sound produced by the contact between the opposing surfaces that is audible to the user who has connected the cartridge. Preferably the audible signal comprises a peak intensity of at least 30 dB (logarithmically averaged a-weighted sound pressure level), more preferably at least 40 dB such that the audible signal can be heard by the user in the presence of significant background noise. Preferably the audible signal is a sharp sound of short duration such that it more precisely indicates the point of connection. Preferably the audible signal has a duration of less than 0.5 seconds, more preferably 0.3 seconds or less, most preferably less than 0.2 seconds, where the decreasing duration provides an increasingly reliable indication of the point of mechanical and electrical connection. Preferably the audible signal has a frequency response with an intensity peak between 2.5 kHz and 8 kHz, i.e. preferably there is a peak intensity in one of the following ⅓ octave frequency bands: 2.5 kHz, 3.15 kHz, 4 kHz, 5 kHz, 6.3 kHz or 8 kHz. This ensures that the audible signal is readily identifiable to a user, even against significant environmental background noise. Preferably the overall peak intensity in the ⅓ octave response falls within this frequency range. In other examples the audible signal may have an additional intensity peak within a lower frequency range, for example 100 to 160 Hz.

The opposing contact surfaces may be provided, for example, by: a surface of a rim surrounding an opening of the cavity and an opposing surface of the cartridge; or the inner base surface of the cavity and the opposing base surface of cartridge.

Although the invention is illustrated using the example of an electronic cigarette and a cartridge of liquid aerosol generating material, it is clear that the inventive concepts presented herein and defined in the appended claims are distinct from the specific type of aerosol generating device and the mechanism by which the vapour is formed. Therefore the concept defined above and in the following disclosure can also be realised in any form of aerosol generating device which includes a removable cartridge or capsule. For example, e-cigarettes or heat-not-burn devices where the cartridge contains any form of aerosol generating material, for example cartridges containing tobacco material or induction heated capsules can equally be used if they comprise they characteristics defined in the appended claims.

Preferably the cartridge, the cartridge seating and the magnetic force are configured such that the audible signal generated is substantially constant irrespective of the orientation of the device, in particular when the device is vertically orientated or horizontally orientated.

The process in which the audible signal is generated is as follows. When the cartridge is placed within the cavity and released, the magnet provides a magnetic force which draws the cartridge into the cavity. The cartridge is accelerated under the action of the magnetic force such that it increases in speed as it moves towards the retained position. When it reaches the retained position the opposing surfaces meet, stopping the further movement of the cartridge. A portion of the kinetic energy of the cartridge at impact ½ mv² is converted into sound energy to produce the audible signal, the proportion primarily depending on the surface hardness of the opposing surfaces. Therefore by appropriately configuring the cartridge, cartridge seating and the magnetic force provided by the magnetic connection, the required audible signal can be generated. Values of the magnetic force, the dimensions of the cartridge seating, the mass of the cartridge and the materials of the opposing surfaces of the cartridge and cartridge seating may be selected through experimentation to provide the audible signal. Exemplary ranges of these parameters are provided below which can advantageously enhance the audible signal and ensure it is consistent irrespective of the orientation of the device, as described below.

The electronic cigarette may include one or more magnets arranged to provide a magnetic connection between the cartridge and inhaler body which provides the defined magnetic force. One or more magnets may be provided on the cartridge, the cartridge seating or both the cartridge and the cartridge seating.

Preferably the cartridge seating comprises a magnet and the cartridge comprises ferromagnetic material. The ferromagnetic material may be a steel such as stainless steel. This provides a strong response to the magnetic field of the magnet and a high surface hardness such that the kinetic energy of the cartridge on impact is efficiently converted to sound energy in the audible signal.

Preferably the ferromagnetic material is provided as a layer on the base surface of the cartridge. Alternatively, the ferromagnetic element can be provided as an end-plug and can be configured to seal the bottom of the cartridge.

Preferably the one or more magnets provide a total flux density between 500 and 10,000 gauss, more preferably between 500 and 5000 gauss. In some examples of the invention the one or more magnets provide a total magnetic flux density of between 3000 gauss and 15000 gauss, more preferably at least 4000 gauss. A magnetic flux within these ranges provides a strong magnetic force to reliably draw the cartridge into the retained position and accelerate it sufficiently to provide the required audible signal. Preferably the magnets provide a total flux density between 500 and 5000 gauss. This provides a good balance between the strength of magnetic force to produce the click and cost of the magnetic components. It further ensures the cartridge is easy to release from the retained position with one hand. Magnetic flux in this range further ensures the audible signal is substantially constant irrespective of the orientation of the device. Using magnetic flux density within these ranges therefore ensures the magnet is strong enough to draw the capsule into the cavity and seat the capsule correctly. It further ensures that the cartridge is subsequently remains correctly seated during use and transport of the device, while ensuring the magnetic force is not so strong that the cartridge cannot be easily and conveniently removed by the user.

Providing magnets of strength between the above ranges means the magnetic force is much more significant than the force due to gravity. This helps ensure the acceleration and therefore the intensity of the audible signal is substantially constant irrespective of the orientation of the device, i.e. the audible signal is of substantially the same intensity whether the device is vertically orientated or horizontally orientated.

In some examples of the invention the one or magnets may be electromagnets wherein a current is applied to the electromagnets, for example following a user activation, to apply the magnetic force to draw and/or hold the cartridge in the retained position.

Preferably the magnetic force applied by the magnet and the mass of the cartridge are configured such that an acceleration of the cartridge under the force of the magnet is at least 10 m/s², preferably at least 12 m/s². This ensures the cartridge reaches a sufficient speed on impact to produce the audible signal for a wide range of dimensions of the cartridge seating.

Preferably the mass of the cartridge when full is between 1 and 20 g, preferably between 2 and 20 g, more preferably between 5 and 10 g. In particularly preferably examples of the invention the mass of the cartridge is between 1.5 and 10 g. This ensures the kinetic energy on impact is sufficient such that a sufficient amount of sound energy is converted for wide ranges of other parameters of the device, such as surface hardness and depth of the cavity, the latter range helping to ensure that the audible signal is consistent irrespective of the orientation of the device.

Preferably the magnetic force applied by the magnet, the mass of the cartridge and the depth of the cavity of the cartridge seating is configured such that the cartridge reaches a speed of at least 0.4 m/s, preferably at least 0.7 m/s, upon contact between the opposing surfaces when released from the opening of the cavity. This ensures the kinetic energy on impact is sufficient such that a sufficient amount of sound energy is converted for wide ranges of other parameters of the device, such as surface hardness and mass.

Preferably the depth of the cavity is 10-30 mm, preferably 15-25 mm. These ranges provide a sufficient range of motion of the cartridge to ensure it reaches a sufficient speed and accordingly kinetic energy while maintaining reasonable dimensions of the device such that it remains easy to handle and use.

Preferably each of the opposing contact surfaces has a Brinell harness value of greater than 50, more preferably greater than 70. Alternatively, preferably each of the opposing contact surfaces has a Hardness Rockwell R-scale value of greater than 75, more preferably 95. Values in these ranges ensure that a sufficient proportion of the kinetic energy is converted to sound energy in the audible signal for a wide range of parameters.

Preferably the magnet is configured such that the magnetic force is sufficient to draw the cartridge into the retained position, only when the cartridge is partially inserted into the cavity by a user. This ensures that the magnetic force only acts when the cartridge is positioned within the cavity opening, preventing the force acting when the cartridge is not correctly positioned. This ensures that a user must initially position the cartridge within the cavity before releasing to seat the cartridge and ensures the user firstly correctly orientates the cartridge to achieve correct seating of the cartridge whilst improving ease of use as the user must only initially position the cartridge before the magnetic force acts to seat the cartridge. Preferably the magnet is configured to apply a sufficient force to draw the cartridge into the cavity only when the cartridge is inserted at least 10% of the depth of the cavity by a user. More preferably the magnet is configured to apply a sufficient force to draw the cartridge into the cavity only when the cartridge is inserted at least 25% of the depth of the cavity by a user, preventing it from falling out of the cavity when released by a user if the device is not held vertically.

Preferably the cartridge is drawn into the retained position in a single, uninterrupted motion such that no further force need be applied by a user, thus making the cartridge more straightforward to insert and ensuring there is only one contact point and associated audible signal such that this can be reliably associated with the point of mechanical and electrical connection.

Preferably the cavity comprises an inner base surface, the base surface having a recessed portion. In this way if any liquid leaks from the cartridge or if condensation collects in the cartridge seating, the liquid will preferentially collect in the recess such that it does not damp the contact between the opposing surfaces producing the audible signal. Preferably the recessed portion is centrally positioned on the base surface of the cavity. Alternatively it may be provided around the circumference of the base surface of the cavity.

Preferably the base of the cavity comprises electrical connectors that are raised from the inner base surface of the cavity and are elastically sprung so as to be retractable into the inner base surface upon contact with the cartridge.

Therefore electrical contact between the electrical connectors and corresponding contacts on the cartridge can be ensured as the electrical connectors are raised but the contact between opposing surfaces is damped as the electrical connectors are retractable.

Preferably the base of the cavity comprises electrical connectors and at least two magnets, wherein the electric connectors are preferably placed in a central portion of the base and the at least two magnets are preferably placed on opposite sides of the electric connectors. A plurality of magnets ensure that the cartridge is connected evenly to the cartridge seating. This ensures that the magnetic attraction force is not concentrated to a single point, but instead spread out to secure the full base surface of the cartridge to the cartridge seating. If the cartridge has a substantially rectangular base surface, it is advantageous to provide two magnets located on each extremity of the rectangular base. This also simplifies the arrangement of the electrical contacts, as they can be placed in between the magnets and thus axially centred with the heating element.

Preferably the cartridge and/or cartridge seating are configured such that there are one or more gaps between the cartridge and cartridge seating as the cartridge is drawn into the retained position. This allows air to escape the cavity as the cartridge is drawn into the received position preventing damping of the contact by the pressure or air trapped between the opposing contact surfaces. It further prevents an air flow sensor (used to turn the heater on when the user inhales) being triggered by an increased air pressure from the cartridge entering the cavity.

Preferably the cartridge comprises ribs running along the longitudinal axis of the cartridge or the cartridge seating comprises ribs running along the inner surfaces along the longitudinal direction. The longitudinal direction is the direction of insertion of the cartridge. The ribs provide air channels between the cartridge and cartridge seating through which air can escape from the cavity as the cartridge is inserted. They further reduce friction, such that the impact speed is increased.

Preferably the cartridge comprises one or more circumferential ribs running around the cartridge, substantially perpendicular to the insertion direction. Perpendicular ribs reduce friction and may be used to alter the characteristics of the audible signal. Preferably the cartridge seating comprises protrusions arranged to contact the circumferential ribs to produce a series of audible signals as the cartridge moves into the retained position. The audible signal produced on final contact in the retained position may be different from the audible signals produced by the ribs during movement of the cartridge so that the point of connection can be reliably determined.

Preferably the cartridge seating comprises an elastic member arranged such that the cartridge displaces and releases the elastic member as it moves into the retained position thus creating an additional audible signal.

Preferably the electronic cigarette comprises a cartridge of mass between 2 g and 10 g, the cartridge having a base comprising a ferromagnetic material; one or more magnets having a total flux density of between 500 and 5000 gauss; a cavity with an insertion depth of at least 10 mm; and opposing contact surfaces comprising metal or rigid plastic. In some examples the magnets may have a flux of at least 4000 gauss to provide an increased securing force to seat the cartridge.

In some examples the electronic cigarette comprises: a cartridge of mass between 2 g and 20 g, the cartridge having a base comprising a ferromagnetic material; a magnet of flux of at least 4000 gauss; a cavity with an insertion depth of at least 10 mm; and opposing contact surfaces comprising metal or rigid plastic.

The inventors have determined that a device with these parameters provides a strong reliable audible signal which is substantially constant for any orientation of the device between horizontal and vertical.

According to a further embodiment of the present invention, the cartridge can contain a tobacco substrate, such as ground tobacco powder or shredded tobacco immersed with an aerosol-forming substance. Such a cartridge can be used in a main inhaler device configured to heat the tobacco to a temperature at which vaporization occurs. The tobacco cartridge can be formed from a ferromagnetic material which is attracted by at least one magnet located in the bottom of a cartridge seating. In a similar way as described in connection with liquid cartridges, an audible sound is generated once the cartridge contacts the bottom of the cartridge seating. This enables the user to determine that the cartridge is mechanically connected and electrically (or thermally) connected to the main device.

The tobacco inside the cartridge can be heated by induction or by conduction. Alternatively, the cartridge can be infused by vapour coming from a second liquid cartridge arranged upstream the tobacco cartridge along the vapour flow path through the electronic cigarette.

### BRIEF DESCRIPTION OF THE FIGURES

FIG. 1 schematically illustrates an electronic cigarette according to the present invention.

FIG. 2 schematically illustrates an electronic cigarette according to the present invention in which the internal components of the inhaler body and the cartridge are shown.

FIG. 3 schematically illustrates an electronic cigarette in which the cartridge is partially received in the cartridge seating.

FIG. 4 is a graph showing the intensity of the audible signal generated when the cartridge is released in both the vertical and horizontal positions.

FIG. 5 is an end view into the cavity of the inhaler body.

FIGS. 6a and 6b schematically illustrates an alternative cartridge for use with the present invention.

FIG. 7 schematically illustrates an alternative cartridge for use with the present invention.

### DETAILED DESCRIPTION

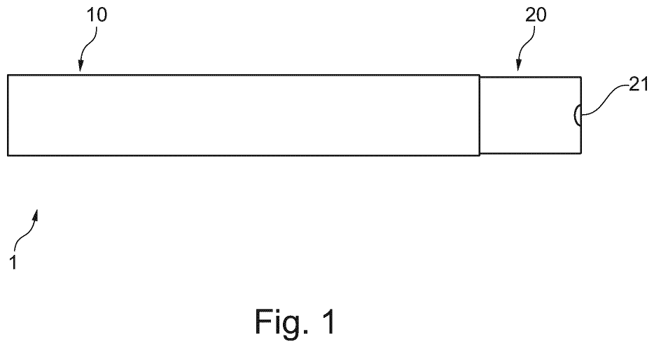

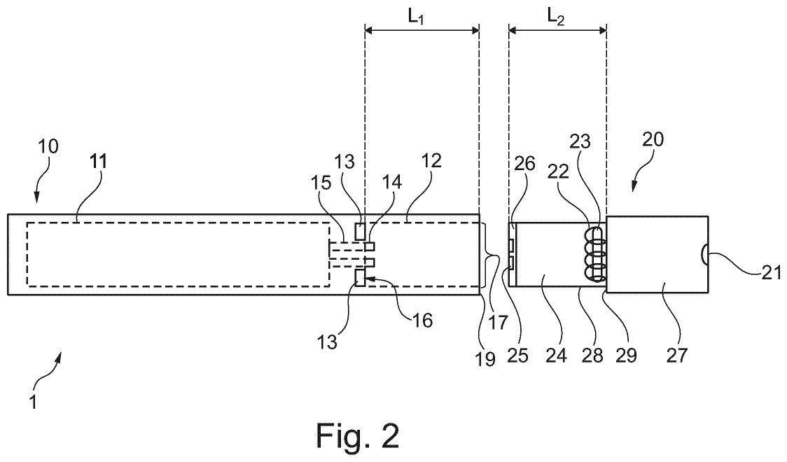

FIG. 1 schematically illustrates an electronic cigarette 1 according to the present invention which includes an inhaler body 10 and a removable cartridge 20. As shown in the internal view of FIG. 2, the inhaler body 10 includes a power unit 11 and a cartridge seating 12. A cartridge seating 12 is arranged to receive the removable cartridge 20 in a retained position, as shown in FIG. 1, in which opposing surfaces of the cartridge 20 and cartridge seating are in contact and the cartridge 20 is electrically connected to the power unit 11.

The electronic cigarette 1 further comprises a magnet 13 arranged to provide a magnetic force to draw the removable cartridge 20 into the retained position. The surface hardness of the opposing surfaces of the cartridge 20 and cartridge seating 12 and the force applied by the magnet 13 are configured such that an audible signal is generated upon contact between the opposing surfaces of the cartridge 20 and the cartridge seating 12 when the cartridge 20 is drawn into the retained position by the magnet 13, as shown in FIG. 1.

In other examples of the invention the magnetic connection may be provided by a magnet on the cartridge and magnetic material or a further magnet positioned in the cartridge seating.

In the example of FIGS. 1 and 2, the inhaler body 20 has an elongate shape, with the cartridge seating provided at one end. The cartridge 20 can therefore provide the mouthpiece of the device, being positioned at a proximal end and having an air outlet 21 through which generated vapour may be inhaled by the user. The cartridge 20 is therefore shaped such that the proximal end with the air inlet 21 has a shape configured such as to allow a user to inhale the vapour from one end.

In the example shown in the figures, the cartridge 20 comprises a cartomizer which includes a heater assembly in the form of a heating coil 22 wrapped around a wick 23 which is arranged so as to transfer liquid held in a reservoir 24 to the heating coil such that it may be vaporized, with the generated vapour inhaled through the outlet 21. Electricity is supplied to the heating coil from the power supply 11 when the cartridge 20 is received in the retained position within the cartridge seating 12. In particular, the cartridge seating 12 comprises two or more contacts 14 which are connected to the power supply 11 via electrical circuitry 15, such that when the cartridge 20 is received within the cartridge seating 12, the contacts 14 of the cartridge seating 12 are in electrical contact with corresponding contacts 25 on the cartridge 20, thereby allowing electricity to flow from the power supply 11 to the heating coil 22.

In the example shown in the figures two magnets 13 are provided at the inner base surface 16 of the cartridge seating 12 and ferromagnetic material 26 is provided on the opposing base surface 26 of the cartridge 20. The ferromagnetic element may be provided as a layer deposited directly onto the bottom surface of the cartridge. Alternatively, the ferromagnetic element can be provided as an end-plug and can be configured to seal the bottom of the cartridge and accommodate the electrical wiring to the heating element. In this way, the magnets 13 are configured so as to attract the ferromagnetic base surface 26 of the cartridge.

In particular, when the cartridge 20 is brought within range of the magnets 13 such that the force increases above a threshold, the cartridge 20 is drawn into the cartridge seating 12 such that the ferromagnetic base surface 26 of the cartridge 20 is brought into contact with the base surface 16 of the cartridge seating. In this retained position, shown in FIG. 1, the base surface 16 of the cartridge seating is in contact with the opposing surface 26 of the cartridge such that the corresponding contacts 14 of the cartridge seating 12 are in contact with the contacts 25 of the cartridge 20. Preferably, the magnetic connection elements 13 are recessed in the device housing and separated in relation to each other such that the at least one magnet and the ferromagnetic element are arranged at a distance from each other when the cartridge is seated in the cartridge seating.

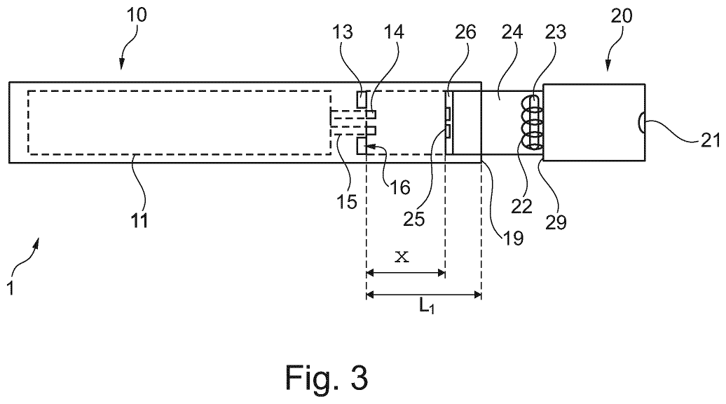

The cartridge seating 12 is provided as a cavity being appropriately shaped to accept a portion 28 of the cartridge 20 when in the retained position. In particular, the cavity 12 may be a hollow elongate recess positioned at one end of the inhaler body 10 so as to accept the cartridge 20 through the end opening 17, as shown in FIG. 3. The cavity 12 of the cartridge seating and the shape of the cartridge 20 are configured such that when the cartridge 20 is received in the retained position, as shown in FIG. 1, a portion of the cartridge extends out of the cavity 12 providing the mouthpiece of the device 1. The magnets 13 and electrical contacts 14 are provided on the inner base surface 16 of the cavity 12. That is, they are provided on the far surface, in the insertion direction, which is perpendicular to the elongate axis and insertion direction in the exemplary embodiment shown in the figures.

As described, the magnets 13 are configured to provide an appropriate magnetic force such that when the cartridge 20 is partially inserted into the cavity 12 as shown in FIG. 3 and released, the magnets provide a sufficient force to draw the cartridge 20 in to the retained position causing a sharp contact between the base surface 16 of the cavity 12 and the opposing surface 26 of the cartridge 20. The magnets 13 are configured to provide a sufficient magnetic force relative to the weight of the cartridge 20 such that the acceleration of the cartridge 20 is sufficient to cause the cartridge 20 to reach a speed such that the contact between the opposing surfaces provides an audible signal in the form of a sharp noise or “click”. This noise is generated as the opposing surfaces 16, 26 come into contact which provides a feedback signal to the user that the cartridge 20 is both mechanically and electrically connected to the inhaler body 10.

Since the contacts 14 are provided on the base surface 16 of the cartridge seating 12, contact between these surfaces provides a reliable audible indicator that the cartridge is electrically connected to the power supply 11. The user then knows the cartridge is properly engaged and the device 1 is ready for use.

The inventors have found that the magnetic flux, surface hardness of the opposing surfaces, the mass of the cartridge 20 when full and the distance through which the cartridge moves before the opposing surfaces come into contact may be selected in order to provide a strong audible signal indicating the mechanical and electrical connection of the cartridge and inhaler body 10 is established. A problem to be solved was to achieve a sufficient audible signal by using magnets of minimum strength. This reduces the cost for the magnets and enhances the user friendliness as the cartridge can be easily introduced into the cartridge seating before being attracted by the magnetic force.

The inventors have discovered that a reliable audible signal can be generated, which is substantially independent of device orientation with an electronic cigarette with a cartridge of mass between 2 g and 20 g, the cartridge having a base comprising a ferromagnetic material; one or more magnets having a total flux of at least 4000 gauss; a cavity with an insertion depth of 10 to 30 mm; and opposing contact surfaces comprising metal or rigid plastic.

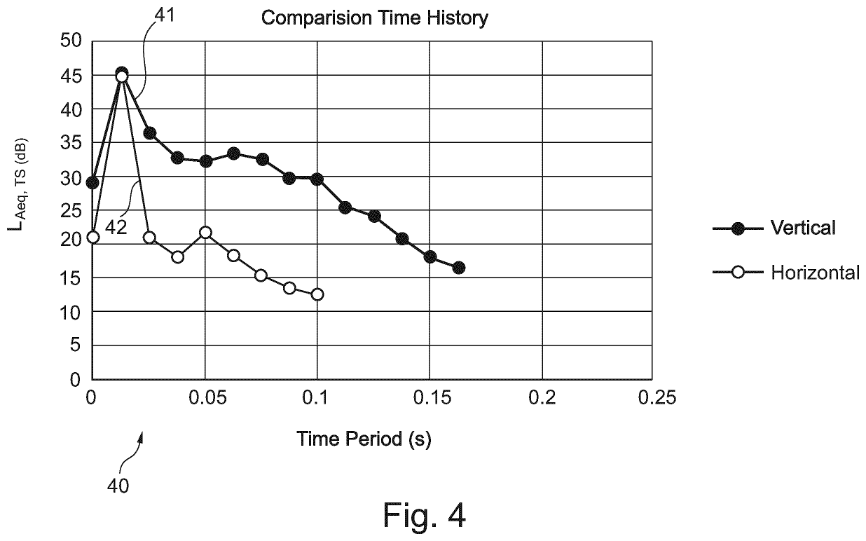

The inventors surprisingly discovered that a magnetic flux in this range is able to provide a constant peak intensity of the audible signal generated, irrespective of the orientation of the device. This is important to provide a consistent audible connection signal to the user so that it is clearly communicated to the user that the connection is established. For instance, if the audible signal would have an inconsistent strength depending of the orientation of the device, it is not clear to the user if the cartridge is properly connected in the cartridge seating. FIG. 4 shows a comparison between the noise generated by the cartridge being drawn into the retained position, when the inhaler body is oriented in a vertical 41 and horizontal 42 position, indicated by the lines 41, 42 of the graph 40 of FIG. 4. A reliable and consistent feedback signal is thereby generated irrespective of the orientation of the device 1 to inform the user that the cartridge 20 is both electrically and mechanically connected to the power supply 11.

This magnetic force and the associated strong audible signal, irrespective of device 1 orientation, was provided as a way of example by the selection of the following parameters, whereby the broadest range ensures the response as shown in FIG. 4 and the more preferably narrower ranges provide a louder shorter signal, while optimising the size and cost of the components.

### Example 1

The weight of the cartridge when full: 1 to 20 g, preferably 1.5 to 10 g or 5 to 10 g. Total flux density provided by magnets: over 2500 gauss, preferably between 4000 and 10000 gauss.

Depth of the chamber L: at least 5 mm, preferably 10 to 30 mm.

Surface hardness of each of the opposing surfaces: greater than 50 Brinell hardness value (or hardness Rockwell R-scale value of greater than 70). In practice appropriate hardness may be provided by a rigid plastic or metal surface material.

The minimum speed of the cartridge on impact: 0.4 m per second, preferably at least 0.7 m per second. Speeds in this range are generated by selecting the above parameters in the indicated ranges.

It will be appreciated that the above parameters provide only an example of suitable parameters which may provide a reliable audible signal. These may be selected to provide an appropriate audible signal for the device, the above broad ranges defining parameters which provide the response as shown in FIG. 4 in which the peak intensity of the audible signal remains equal for both the vertical and horizontal orientations of the device. This provides an important advantage in that the mechanical and electrical connection of the cartridge 20 with the inhaler body 10 can be confirmed irrespective of the orientation of the device.

The magnets 13 may be configured such that the magnetic force exceeds the threshold required for drawing the cartridge 20 into the retained position when the cartridge 20 is inserted a certain percentage of the total depth L₁ of the cavity 12, such that it is accelerated through the remaining distance x, as shown in FIG. 3. In particular, the magnets may be configured such that the cartridge is drawn into the retained position when the cartridge is inserted at least 10% of the total distance L₁ of the cavity 12. This gives rise to a sufficient acceleration distance and encourages the user to place the cartridge within the cavity before releasing to prevent the cartridge falling out of the device before it is in range of the magnets. This can be increased to 25% to ensure this is the case even irrespective of the orientation of the device between vertical and horizontal.

Table 1 below shows averaged test data for a device having parameters within the above ranges. In particular, it shows the variation in the total intensity L_{Aeq,Ts} and peak intensity LA_{pk,0.025s} of the audible signal when the cartridge 20 is released within the cavity 12 in both the vertical and horizontal orientations with a full, half full and empty cartridge 20. For each test, six individual repeat measurements have been logarithmically averaged to provide a-weighted equivalent sound pressure level L_{Aeq,Ts} for the complete noise emission period of the product in each orientation. The highest 0.025 s period within each of the six individual repeat measurements have been logarithmically averaged for each test, providing a maximum peak (LA_{pk,0.025s}) level for each test condition.

TABLE 1

| | | |
|---|---|---|
| | L_{Aeq, Ts} | L_{Apk, 0.025 s} |
| Test specimen details (+ duration) | (dB) | (dB) |

VERTICAL

| | | |
|---|---|---|
| Full Cartomiser (0.28 seconds) | 36.6 | 45.8 |
| Half Full Cartomiser (0.27 seconds) | 41.1 | 50.7 |
| Empty Cartomiser (0.3 seconds) | 46.5 | 56.9 |

HORIZONTAL

| | | |
|---|---|---|
| Full Cartomiser (0.19 seconds) | 35.2 | 43.6 |
| Half Full Cartomiser (0.2 seconds) | 39.0 | 47.6 |
| Empty Cartomiser (0.16 seconds) | 52.3 | 61.0 |

The average data in the table above shows that, irrespective of how full the cartridge 20 is, the difference between the peak intensity when released in the vertical or horizontal orientations is less than 8% such that a strong reliable audible signal can be used irrespective of the orientation of the device to provide feedback to the user that the cartridge is both electrically and mechanically connected when the cartridge 20 is received in the device 1.

Preferably the audible signal comprises a peak intensity of at least 40 dB (logarithmically averaged a weighted sound pressure level) in order to provide a strong reliable audible signal to the user. Preferably the audible signal has a duration of less than 0.5 seconds to provide a sharp signal illustrative of the point of contact between the opposing surfaces and the associated connection to the power supply 11.

The audible signal may also be categorised by the frequency response, in particular the intensity (dB) of different frequency bands within the click. The parameters of the electronic cigarette and cartridge are preferably selected to provide a frequency response which is readily identifiable by the user and is clearly audible against background noise. The frequency response may be categorised by the ⅓ octave band of the click. The ⅓ octave band of a device falling within the definitions of example 1 above is displayed in Table 2, provided as an annex. Table 2 shows the a-weighted equivalent sound pressure level L_{Aeq} for the complete noise emission period and the peak average (both in dB) in the second column. The sound pressure level (in dB) is also shown for each ⅓ octave band from 100 Hz to 10 kHz for each fill level of the cartridge and orientation.

An audible signal with the form of frequency response indicated in Table 2 is particularly clear and identifiable against background noise. In particular it is preferable that the peak of the audible signal, e.g. the 0.025 seconds in which the peak intensity of the audible signal occurs, has a maximum intensity at a frequency between 2.5 and 8 kHz. This makes the audible signal readily identifiable. Similarly it is preferably that the audible signal overall has a peak intensity in the range 2.5 to 8 kHz. In some cases the audible signal may also have a peak at very low frequencies, e.g. in the 100 or 125 Hz bands, which is more difficult to identify by a user, but the important feature is that there is an intensity peak between 2.5 kHz and 8 kHz, i.e. in the 2.5 kHz, 3.15 kHz, 4 kHz, 5 kHz, 6.3 kHz or 8 kHz ⅓ octave bands.

The electronic cigarette may further be provided with additional features that optimise the audible signal generated when the cartridge 20 is received in the cartridge seating 12. Firstly, the contacts 14 of the cartridge seating may be raised from the inner base surface 16 of the cavity but are elastically sprung such that they are retractable into the base surface 16 of the cavity 12 under contact with the cartridge 20. This ensures that the contact form a good connection with the corresponding contacts 25 on the base surface 26 of the cartridge 20 as they are biased into a protruding arrangement as shown in FIG. 2 such that they press against the base surface 26 of the cartridge 20. However, because they are retractable under force, they do not significantly dampen the contact between the opposing surfaces of the cartridge seating 12 and the cartridge 20 so that they only have a negligible if any effect on the intensity of the audible signal generated by contact between the opposing surfaces.

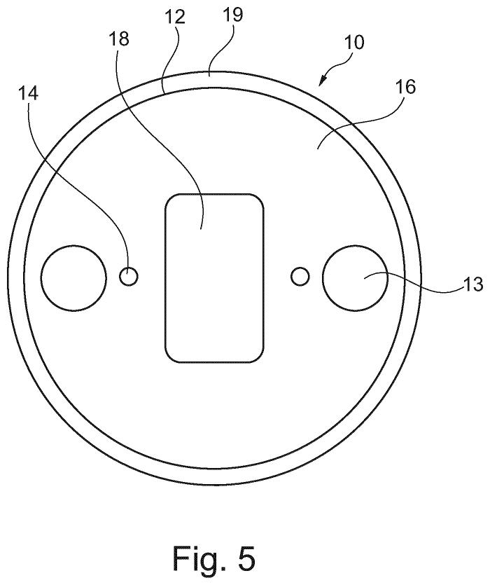

FIG. 5 shows an end view of the inhaler body 10 looking into the opening 17 of the cavity 12 forming the cartridge seating. On the base surface 16 of the cavity 12 there is provided two magnets 13 and the retractable contact pins 14. The electric connectors 14 are positioned in a more central portion of the base surface 16 relative to the magnet 13. This spaced apart arrangement reduces interference between the magnets 13, ensuring the magnetic force applied by the field is appropriate to provide the above described effect in terms of the audible signal. FIG. 5 further shows a recessed portion 18 provided in the base surface 16 of the cavity 12. The recessed portion 18 has a greater depth than the remainder of the cavity. The recess portion 18 is arranged to collect any liquid present in the base of the chamber 12. In particular, any liquid will preferentially collect in the recess portion 18 rather than the surrounding surface 16 at the base of the cavity 12. For example, liquid due to condensation might collect at the base of the cavity or liquid which has leaked from the reservoir 24 of the cartridge 20 may pull in the bottom of the chamber 12.

Any liquid collecting in this area may dampen the contact between the opposing surfaces 16, 26 as the cartridge is received in the cartridge seating 12, reducing the intensity or changing the characteristics of the audible signal generated. By providing a recess portion 18 which collects the liquid, this problem is overcome as the remainder of the contact surface 16 stays substantially liquid free and therefore a sharp contact is provided as required. The surface may equally be partially sloped down toward the recess portion 18 to aid with the collecting of liquid.

In alternative examples of the present invention, the depth of the cavity L1 may be slightly greater than the length of the received portion 28 of the cartridge 20. In particular, the cartridge 20 may comprise a mouthpiece region 27, as shown in FIG. 2, and a received portion 28 arranged to be received by the cavity 12 of the cartridge seating. In the alternative example the length L2 of the received portion 28 in the elongate direction is less than the depth L1 of the cavity such that the base surface of the cartridge 26 contacts the electrical connectors 14 but does not contact the base surface 16 of the cavity 12. Instead, due to its greater diameter, the mouthpiece portion 27 contacts the rim 19 around the opening 17 of the cavity 12. Therefore, in this example, the contact between opposing surfaces producing the audible signal is between the rim 19 of the cavity 12 and the opposing surface 29 of the cartridge 20. The parameters described above apply equally to this example in which the opposing contact surfaces are the rim 19 of the cavity 12 and the opposing rim 29 at the connection between the mouthpiece 27 and received portion 24 of the cartridge 20.

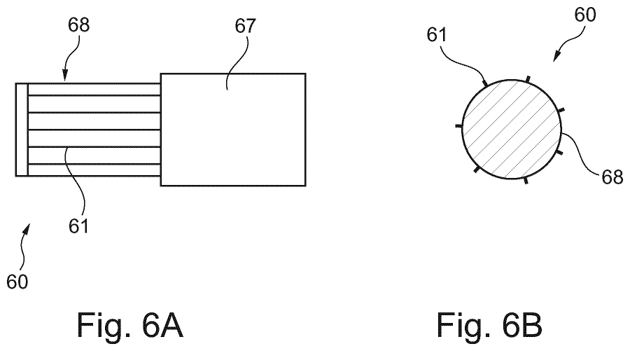

In an alternative example of the cartridge 60 shown in FIGS. 6a and 6b an array of longitudinal ridges 61 are provided around the received portion 68 of the cartridge 60. In particular, a plurality of protruding ridges 61 are provided around the circumference of the portion 68 of the cartridge 60 which is received within the cavity 12 of the inhaler body 10. The longitudinal ridges 61 are arranged to contact the internal side walls of the cavity 12. The provision of these ridges 61 reduces the surface area in contact between the cartridge and internal surfaces of the cavity 12. This reduces any detrimental effect of condensation on the internal walls of the cavity 12 on the motion and corresponding audible signal generated by the cartridge 60. In particular, such condensation can produce a damping effect or prevent air escaping from the cavity 12 around the cartridge 60 thus creating an air cushion which damps the contact between the opposing surfaces and reduces the intensity of the audible signal generated. The ridges ensure there are channels through which the air can escape thus allowing the cartridge 60 to accelerate to an appropriate speed to provide the required intensity in the audible signal. The ridges may be provided around the circumference of the received portion 68 of the cartridge 60 as shown in FIG. 6b. Alternatively, the ridges 61 may be provided on the internal surfaces of the cavity in a corresponding manner to achieve the same effect.

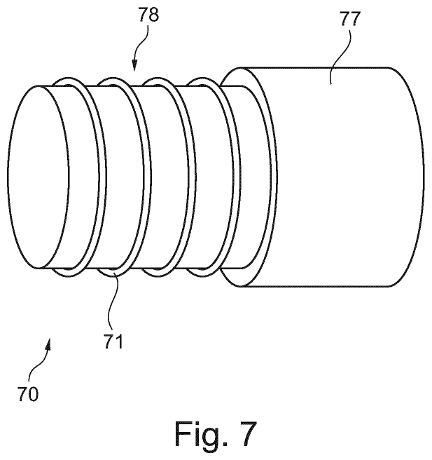

A further alternative example of a cartridge 70 is illustrated in FIG. 7. The cartridge 70 is similar to the cartridge 60 but instead of longitudinal ridges 61 it has circumferential ribs 71 running around the circumference of the received portion 78 of the cartridge 70 at periodic positions along the longitudinal length. These ribs 71 can have a similar effect in reducing surface contact between the cartridge and internal walls of the cavity. Furthermore, the rib 71 can be arranged to contact a portion of the internal surface of the cavity 12 to produce a series of audible signals as the cartridge is pulled into the cavity 12 by the magnets 13. This can prolong and intensify the audible signal to provide greater feedback to the user that the cartridge 70 has been received in the cavity 12. Further means of enhancing the audible signal may be provided. For example an elastic or sprung member may be provided on the inner surface of the cavity 12 which is displaced and released by a protrusion or rib 71 on the cartridge 20 as the cartridge 20 is drawn into the cavity. By priming and releasing a vibrating member in this way a prolonged and distinctive sound can be produced, providing more pleasing audible signal to the user to confirm that the cartridge has been received in the retained position.

| Horizontal - Empty | LAeq | 100 | 125 | 160 | 200 | 250 | 315 | 400 | 500 | 630 | 800 | 1k |
|---|---|---|---|---|---|---|---|---|---|---|---|---|
| Overall Average (0.16 sec) | 52.3 | 22.0 | 22.9 | 25.6 | 24.0 | 26.6 | 21.7 | 21.3 | 18.6 | 22.6 | 29.6 | 29.8 |
| Peak Average (0.025 sec) | 61.0 | 19.9 | 19.3 | 24.0 | 26.6 | 28.2 | 22.7 | 26.9 | 24.5 | 30.3 | 37.7 | 37.9 |

| Horizontal - Empty | 1.25k | 1.6k | 2k | 2.5k | 3.15k | 4k | 5k | 6.3k | 8k | 10k |
|---|---|---|---|---|---|---|---|---|---|---|
| Overall Average (0.16 sec) | 28.5 | 34.7 | 41.9 | 41.9 | 42.4 | 43.5 | 44.9 | 42.4 | 38.7 | 37.9 |
| Peak Average (0.025 sec) | 37.0 | 43.8 | 50.9 | 50.5 | 50.7 | 52.4 | 53.5 | 51.0 | 47.3 | 46.7 |

| Horizontal - Half Full | LAeq | 100 | 125 | 160 | 200 | 250 | 315 | 400 | 500 | 630 | 800 | 1k |
|---|---|---|---|---|---|---|---|---|---|---|---|---|
| Overall Average (0.2 sec) | 39.0 | 21.8 | 22.8 | 26.5 | 23.5 | 23.2 | 19.0 | 18.9 | 20.0 | 24.3 | 29.9 | 29.1 |
| Peak Average (0.025 sec) | 47.6 | 19.4 | 17.9 | 21.0 | 23.2 | 23.3 | 19.1 | 25.8 | 27.5 | 32.5 | 38.3 | 37.5 |

| Horizontal - Half Full | 1.25k | 1.6k | 2k | 2.5k | 3.15k | 4k | 5k | 6.3k | 8k | 10k |
|---|---|---|---|---|---|---|---|---|---|---|
| Overall Average (0.2 sec) | 25.5 | 25.6 | 23.3 | 26.1 | 30.1 | 27.3 | 28.4 | 27.9 | 26.1 | 26.4 |
| Peak Average (0.025 sec) | 34.3 | 34.5 | 32.0 | 34.7 | 38.6 | 35.9 | 37.0 | 36.6 | 34.1 | 34.0 |

| Horizontal - Full | LAeq | 100 | 125 | 160 | 200 | 250 | 315 | 400 | 500 | 630 | 800 | 1k |
|---|---|---|---|---|---|---|---|---|---|---|---|---|
| Overall Average (0.19 sec) | 32.2 | 24.1 | 23.1 | 27.2 | 23.2 | 21.7 | 18.7 | 17.2 | 18.4 | 21.0 | 25.2 | 23.2 |
| Peak Average (0.025 sec) | 43.6 | 22.6 | 16.6 | 19.0 | 20.6 | 20.4 | 15.2 | 22.9 | 25.5 | 28.6 | 32.9 | 30.6 |

| Horizontal - Full | 1.25k | 1.6k | 2k | 2.5k | 3.15k | 4k | 5k | 6.3k | 8k | 10k |
|---|---|---|---|---|---|---|---|---|---|---|
| Overall Average (0.19 sec) | 22.7 | 22.2 | 20.4 | 23.4 | 22.9 | 21.1 | 25.0 | 26.2 | 24.6 | 24.1 |
| Peak Average (0.025 sec) | 30.6 | 30.4 | 28.4 | 31.8 | 31.2 | 29.4 | 33.5 | 34.4 | 32.9 | 32.7 |

| Vertical - Empty | LAeq | 100 | 125 | 160 | 200 | 250 | 315 | 400 | 500 | 630 | 800 | 1k |
|---|---|---|---|---|---|---|---|---|---|---|---|---|
| Overall Average (0.3 sec) | 46.5 | 41.8 | 37.3 | 25.7 | 14.8 | 18.6 | 25.0 | 26.9 | 26.1 | 26.3 | 27.9 | 24.0 |
| Peak Average (0.025 sec) | 56.9 | 22.2 | 21.9 | 12.9 | 18.2 | 23.7 | 28.5 | 33.7 | 35.4 | 35.6 | 37.4 | 33.2 |

| Vertical - Empty | 1.25k | 1.6k | 2k | 2.5k | 3.15k | 4k | 5k | 6.3k | 8k | 10k |
|---|---|---|---|---|---|---|---|---|---|---|
| Overall Average (0.3 sec) | 25.1 | 31.7 | 31.6 | 36.0 | 37.6 | 35.6 | 37.5 | 39.3 | 35.8 | 34.3 |
| Peak Average (0.025 sec) | 34.1 | 41.2 | 41.3 | 46.1 | 47.9 | 45.8 | 47.9 | 49.9 | 46.4 | 44.9 |

| Vertical - Half Full | LAeq | 100 | 125 | 160 | 200 | 250 | 315 | 400 | 500 | 630 | 800 | 1k |
|---|---|---|---|---|---|---|---|---|---|---|---|---|
| Overall Average (0.27 sec) | 41.1 | 43.3 | 38.5 | 27.3 | 16.1 | 20.9 | 29.4 | 31.2 | 24.8 | 22.5 | 25.1 | 25.3 |
| Peak Average (0.025 sec) | 50.7 | 19.9 | 20.1 | 10.8 | 14.7 | 22.4 | 30.4 | 36.2 | 31.9 | 30.3 | 33.5 | 33.7 |

| Vertical - Half Full | 1.25k | 1.6k | 2k | 2.5k | 3.15k | 4k | 5k | 6.3k | 8k | 10k |
|---|---|---|---|---|---|---|---|---|---|---|
| Overall Average (0.27 sec) | 27.2 | 28.9 | 29.3 | 28.8 | 30.3 | 28.5 | 30.8 | 33.4 | 30.7 | 27.7 |
| Peak Average (0.025 sec) | 36.9 | 38.3 | 38.6 | 38.3 | 40.0 | 38.4 | 40.5 | 43.1 | 40.3 | 36.9 |

| Vertical - Full | LAeq | 100 | 125 | 160 | 200 | 250 | 315 | 400 | 500 | 630 | 800 | 1k |
|---|---|---|---|---|---|---|---|---|---|---|---|---|
| Overall Average (0.28 sec) | 36.6 | 45.8 | 38.9 | 27.9 | 16.8 | 22.1 | 29.5 | 29.0 | 26.1 | 24.5 | 26.8 | 26.3 |
| Peak Average (0.025 sec) | 45.8 | 22.1 | 19.5 | 12.6 | 18.9 | 26.2 | 32.8 | 35.7 | 34.3 | 33.2 | 35.8 | 35.0 |

| Vertical - Full | 1.25k | 1.6k | 2k | 2.5k | 3.15k | 4k | 5k | 6.3k | 8k | 10k |
|---|---|---|---|---|---|---|---|---|---|---|
| Overall Average (0.28 sec) | 22.8 | 20.2 | 20.7 | 22.1 | 24.2 | 21.7 | 22.6 | 25.5 | 24.4 | 23.1 |
| Peak Average (0.025 sec) | 32.2 | 29.9 | 30.3 | 31.5 | 33.7 | 31.2 | 31.8 | 35.2 | 34.0 | 32.9 |

1. An electronic cigarette comprising an inhaler body and a removable cartridge, the inhaler body comprising:
a power unit and a cartridge seating, the cartridge seating comprising a cavity arranged to receive the removable cartridge in a retained position within the cavity, wherein, in the retained position, opposing surfaces of the removable cartridge and the cartridge seating are in contact and the removable cartridge is electrically connected to the power unit; the electronic cigarette further comprising:
a magnet arranged to provide a magnetic force to draw the removable cartridge into the retained position; wherein
the removable cartridge, the cartridge seating and the magnetic force are configured such that when the removable cartridge is released within the cavity, the removable cartridge is accelerated under the magnetic force such that an audible signal is generated upon contact between the opposing surfaces as the removable cartridge is received in the retained position.

2. The electronic cigarette of claim 1, wherein the cartridge seating includes the magnet and the removable cartridge comprises ferromagnetic material.

3. The electronic cigarette of claim 2, wherein the magnets and the ferromagnetic material provide a total flux density between 4000 and 10,000 gauss.

4. The electronic cigarette of claim 1, wherein the magnetic force applied by the magnet and a mass of the removable cartridge are configured such that an acceleration of the removable cartridge under the magnetic force is at least 12 m/s².

5. The electronic cigarette of claim 1, wherein the magnetic force applied by the magnet, a mass of the removable cartridge and a depth of the cavity of the cartridge seating are configured such that the removable cartridge reaches a speed of at least 0.4 m/s upon contact between the opposing surfaces when the removable cartridge is released from an opening of the cavity.

6. The electronic cigarette of claim 1, wherein each of the opposing surfaces has a Brinell harness value of greater than 50 or a Hardness Rockwell R-scale value of greater than 75.

7. The electronic cigarette of claim 1, wherein the magnet is configured such that the magnetic force is sufficient to draw the removable cartridge into the retained position only when the removable cartridge is partially inserted into the cavity by a user.

8. The electronic cigarette of claim 7, wherein the magnet is configured such that the magnetic force is sufficient to draw the removable cartridge into the cavity only when the removable cartridge is inserted at least 10% of a depth of the cavity by a user.

9. The electronic cigarette of claim 1, wherein the cavity comprises a base having an inner base surface with a recessed portion.

10. The electronic cigarette of claim 9, wherein the base of the cavity comprises electrical connectors and the magnet, which is at least two magnets, wherein the electric connectors are in a central portion of the base and the at least two magnets are on opposite sides of the electric connectors.

11. The electronic cigarette of claim 10, wherein the electrical connectors are arranged to contact corresponding electrical contacts on the removable cartridge, wherein the electrical connectors are raised from the inner base surface of the cavity and are elastically sprung so as to be retractable into the inner base surface upon contact with the removable cartridge.

12. The electronic cigarette of claim 9, wherein the opposing surfaces include: a surface of a rim surrounding an opening of the cavity and an opposing surface of the removable cartridge; or the inner base surface of the cavity and an opposing base surface of the removable cartridge.

13. The electronic cigarette of claim 1, wherein the removable cartridge and/or the cartridge seating are configured such that there are one or more gaps between the removable cartridge and the cartridge seating as the removable cartridge is drawn into the retained position.

14. The electronic cigarette of claim 13 wherein the removable cartridge comprises ribs running along a longitudinal axis of the removable cartridge.

15. The electronic cigarette of claim 1, wherein the removable cartridge has a mass between 2 g and 10 g and a base comprising a ferromagnetic material; the magnets has a total flux density of between 500 and 5000 gauss; the cavity has an insertion depth of at least 10 mm; and the opposing surfaces comprise metal or rigid plastic.

16. The electronic cigarette of claim 1, wherein the magnetic force applied by the magnet, a mass of the removable cartridge and a depth of the cavity of the cartridge seating are configured such that the removable cartridge reaches a speed of at least 0.7 m/s upon contact between the opposing surfaces when the removable cartridge is released from an opening of the cavity.
